(19) United States
(12) Patent Application Publication
(10) Pub. No.: US 2023/0278820 A1
(43) Pub. Date: Sep. 7, 2023

(54) SHEET CONVEYING DEVICE AND IMAGE FORMING APPARATUS

(71) Applicant: KYOCERA Document Solutions Inc., Osaka (JP)

(72) Inventors: Toshiaki Inoue, Osaka (JP); Yuya Shimohora, Osaka (JP)

(21) Appl. No.: 18/173,029

(22) Filed: Feb. 22, 2023

(30) Foreign Application Priority Data
Mar. 3, 2022 (JP) 2022-032298

(51) Int. Cl. B65H 9/00; B65H 7/14; B65H 7/10; B65H 9/20; G03G 15/00

(52) U.S. Cl. CPC B65H 9/002; B65H 7/14; B65H 7/10; B65H 9/20; G03G 15/6558; B65H 2404/14212; B65H 2404/1424; B65H 2301/331; B65H 2553/416; B65H 2511/22; B65H 2801/06; G03G 2215/00409; G03G 2215/00556

(57) ABSTRACT

A sheet conveying device of the present disclosure includes: a conveying portion that conveys a sheet in a conveying direction directed toward an image transfer position; a detection portion that detects a conveyance deviation of the sheet conveyed; a sheet correction portion provided on a downstream side of the conveying portion in the conveying direction; and a speed control portion that controls a displacement speed of the sheet correction portion during a displacement process of the sheet correction portion from a sheet acceptance position to a correction completion position. The speed control portion causes the sheet correction portion to be displaced to a setting position set between the sheet acceptance position and the correction completion position at a predetermined first speed, and causes the sheet correction portion to be displaced from the setting position to the correction completion position at a second speed lower than the first speed.

### INCORPORATION BY REFERENCE

This application is based upon and claims the benefit of priority from the corresponding Japanese Patent Application No. 2022-032298 filed on Mar. 3, 2022, the entire contents of which are incorporated herein by reference.

### BACKGROUND

The present disclosure relates to a sheet conveying device capable of conveying sheets, and an image forming apparatus including the sheet conveying device.

An image forming apparatus such as a printer, a copying machine, a facsimile, and a multifunction peripheral including functions of these is provided with a sheet conveying device that conveys a sheet such as a printing sheet to an image transfer position. A conventional sheet conveying device includes a pair of registration rollers for performing a registration operation (also referred to as registration) on a sheet. Here, the registration operation is an operation of applying a conveying force in a conveying direction to a sheet while a tip end of the sheet is butted against a nip portion of the pair of registration rollers at stoppage. By carrying out this registration operation, a tilt of the sheet being conveyed is corrected.

As a device that corrects a tilt of a sheet, conventionally, there is known a skew correction mechanism which includes a rotation mechanism that rotatably supports a sheet being conveyed while nipping the sheet, and causes, when a tilt of the sheet is detected, the rotation mechanism to rotate in a direction of correcting the tilt.

### SUMMARY

A sheet conveying device according to an aspect of the present disclosure includes: a conveying portion that conveys a sheet in a conveying direction directed toward an image transfer position at which an image is transferred onto the sheet; a detection portion that detects a conveyance deviation of the sheet conveyed in the conveying direction; a sheet correction portion that is provided on a downstream side of the conveying portion in the conveying direction and is, when the conveyance deviation is detected by the detection portion, displaced from a predetermined sheet acceptance position to a correction completion position, to correct the conveyance deviation; and a speed control portion that controls a displacement speed of the sheet correction portion during a displacement process of the sheet correction portion from the sheet acceptance position to the correction completion position. The speed control portion causes the sheet correction portion to be displaced to a setting position set between the sheet acceptance position and the correction completion position at a predetermined first speed, and causes the sheet correction portion to be displaced from the setting position to the correction completion position at a second speed lower than the first speed.

A sheet conveying device according to another aspect of the present disclosure includes: a conveying portion that conveys a sheet in a conveying direction directed toward an image transfer position at which an image is transferred onto the sheet; a detection portion that detects a conveyance deviation of the sheet conveyed in the conveying direction; a sheet correction portion that is provided on a downstream side of the conveying portion in the conveying direction, includes a correction roller that conveys the sheet conveyed in the conveying direction, in the conveying direction, and causes, when the conveyance deviation of the sheet is detected by the detection portion, the correction roller to be displaced from a predetermined sheet acceptance position to a correction completion position only by a displacement amount corresponding to the conveyance deviation after the sheet enters the correction roller, to correct the conveyance deviation; and a speed control portion that controls a displacement speed of the correction roller when the correction roller is displaced from the sheet acceptance position to the correction completion position by the sheet correction portion. The speed control portion causes the correction roller to be displaced to a setting position set between the sheet acceptance position and the correction completion position at a predetermined first speed, and causes the correction roller to be displaced from the setting position to the correction completion position at a second speed lower than the first speed.

An image forming apparatus according to another aspect of the present disclosure includes the sheet conveying device, and carries out processing of transferring an image onto a sheet conveyed to an image transfer position by the sheet conveying device.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a perspective view showing a configuration of an image forming apparatus according to an embodiment of the present disclosure;

FIG. 2 is a schematic diagram showing an internal configuration of the image forming apparatus;

FIG. 3 is a schematic diagram showing a peripheral configuration of a sheet conveying path of the image forming apparatus;

FIG. 4 is a block diagram showing a configuration of the image forming apparatus;

FIG. 5 is a schematic diagram showing configurations of a sheet conveying unit and a sheet correction mechanism provided in the image forming apparatus;

FIG. 6 is a schematic diagram showing the configuration of the sheet conveying unit provided in the image forming apparatus;

FIG. 7 is a diagram showing the configuration of the sheet correction mechanism provided in the image forming apparatus;

FIG. 8 is a flowchart showing exemplary procedures of sheet correction processing that is executed by a control portion provided in the image forming apparatus;

FIG. 9 is a flowchart showing exemplary procedures of speed control in tilt correction processing and lateral deviation correction processing that are executed by the control portion provided in the image forming apparatus;

FIG. 10 is a diagram for explaining operations of the sheet conveying unit and the sheet correction mechanism provided in the image forming apparatus;

FIG. 11 is a diagram for explaining operations of the sheet conveying unit and the sheet correction mechanism provided in the image forming apparatus;

FIG. 12 is a diagram for explaining operations of the sheet conveying unit and the sheet correction mechanism provided in the image forming apparatus;

FIG. 13 is a diagram for explaining operations of the sheet conveying unit and the sheet correction mechanism provided in the image forming apparatus;

FIG. 14 is a diagram for explaining operations of the sheet conveying unit and the sheet correction mechanism provided in the image forming apparatus; and

FIG. 15 is a diagram for explaining operations of the sheet conveying unit and the sheet correction mechanism provided in the image forming apparatus.

### DETAILED DESCRIPTION

Hereinafter, an embodiment of the present disclosure will be described with reference to the attached drawings. It is to be noted that the following embodiment is an embodied example of the present disclosure and does not limit the technical scope of the present disclosure.

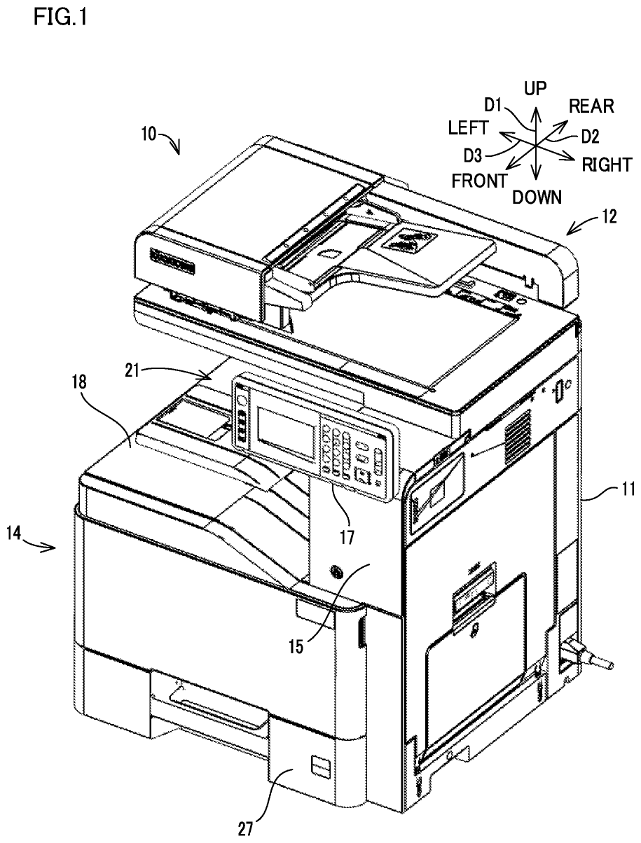

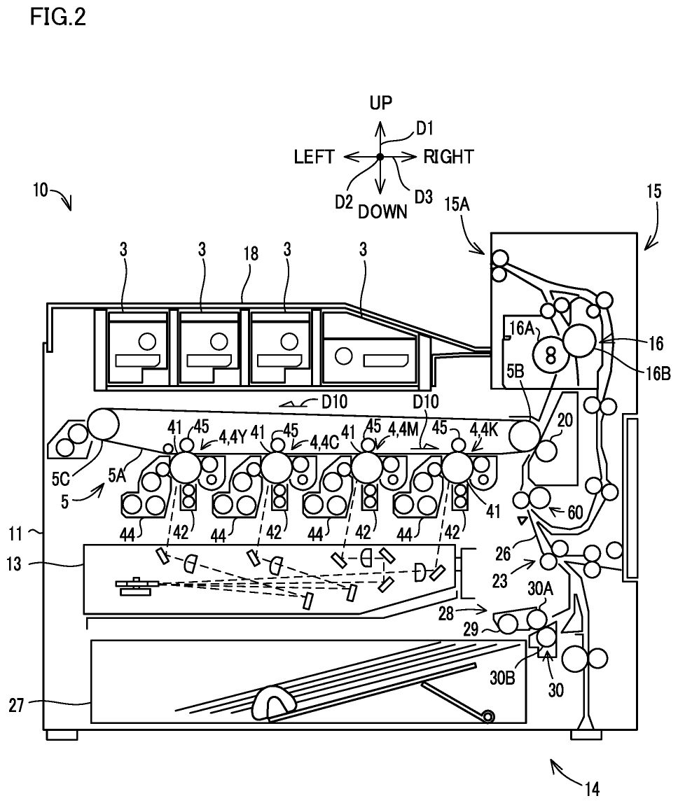

FIG. 1 is a perspective view showing a configuration of an image forming apparatus 10 according to an embodiment of the present disclosure. FIG. 2 is a schematic diagram showing an internal configuration of the image forming apparatus 10. In FIG. 2, an illustration of an image reading portion 12 is omitted. In descriptions below, an up-down direction D1 is defined based on a state where the image forming apparatus 10 is usably installed (a state shown in FIG. 1), a front-rear direction D2 is defined in a state where a front side (front surface side) of the image forming apparatus 10 is assumed to be the front, and a left-right direction D3 is defined in a state where the image forming apparatus 10 is seen from the front side (front surface side).

[Image Forming Apparatus 10]

As shown in FIG. 1, the image forming apparatus 10 is a multifunction peripheral capable of printing an image on a sheet such as a printing sheet, and includes respective functions of a printing function, a copying function, a facsimile function, a scanning function, and the like. The image forming apparatus 10 is not limited to the multifunction peripheral and may be, for example, a printer, a copying machine, a facsimile apparatus, or the like, as long as it is an apparatus including a printing function for printing an image on a conveyed sheet.

The image forming apparatus 10 includes the image reading portion 12 and an image forming portion 14. The image reading portion 12 carries out processing of reading an image of a document sheet, and is provided at an upper portion of the image forming apparatus 10. The image forming portion 14 carries out processing of forming a color image based on electrophotography, and is provided at a lower portion of the image forming apparatus 10. In addition, a sheet discharge portion 15 is provided on a right side of the image forming portion 14.

A discharge space 21 is provided above the image forming portion 14. The sheet discharge portion 15 couples the image forming portion 14 and the image reading portion 12 in the up-down direction while forming the discharge space 21 between the image forming portion 14 and the image reading portion 12.

The sheet discharge portion 15 discharges a sheet, on which an image has been formed, to the discharge space 21. A sheet discharge outlet 15A (see FIG. 2) is formed on a left side surface of the sheet discharge portion 15 on the discharge space 21 side. A sheet is discharged from the sheet discharge outlet 15A.

The image forming portion 14 includes a housing 11 as an apparatus body. Respective portions constituting the image forming portion 14 are arranged inside the housing 11. The housing 11 includes an outer frame that covers the entire image forming portion 14 and an internal frame for supporting the respective portions constituting the image forming portion 14.

FIG. 2 is a schematic diagram showing the internal configuration of the image forming apparatus 10. In FIG. 2, the illustration of the image reading portion 12 is omitted.

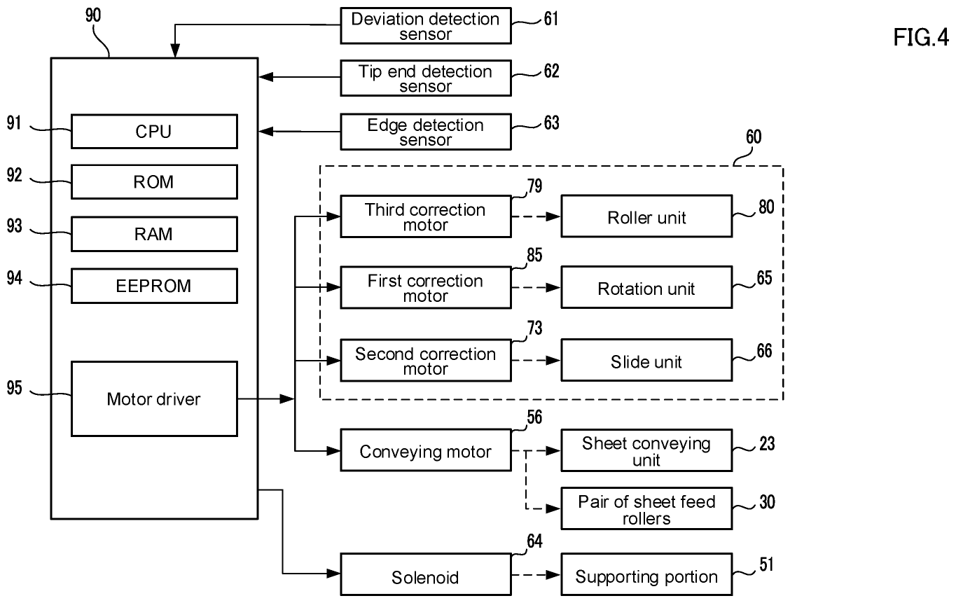

The image forming portion 14 forms a color image on a sheet such as a printing sheet based on a so-called tandem system. As shown in FIG. 2, the image forming portion 14 includes a plurality of image forming units 4, an intermediate transfer unit 5, a laser scanning unit 13, a secondary transfer roller 20, a fixing device 16, a sheet tray 18, a sheet storing portion 27, a sheet feed unit 28, an operation display portion 17 (see FIG. 1), a sheet conveying path 26 (hereinafter, will be referred to as the conveying path 26), a sheet conveying unit 23 (an example of a conveying portion of the present disclosure), a sheet correction mechanism 60 (an example of a sheet correction portion of the present disclosure), a container attachment portion 35, toner containers 3, a control portion 90 (see FIG. 4), and the like.

As shown in FIG. 2, the sheet storing portion 27 is provided at the very bottom of the image forming apparatus 10. The sheet storing portion 27 stores sheets on each of which an image is to be formed by the image forming units 4, and is formed in, for example, a tray shape that is opened upwardly. The sheet storing portion 27 is supported by the housing 11.

The sheet feed unit 28 extracts a plurality of sheets stacked in the sheet storing portion 27 one by one, and feeds the sheets toward the conveying path 26. The sheet feed unit 28 includes a pickup roller 29 and a pair of sheet feed rollers 30. The pickup roller 29 and the pair of sheet feed rollers 30 are provided on an upper side of a right side portion of the sheet storing portion 27.

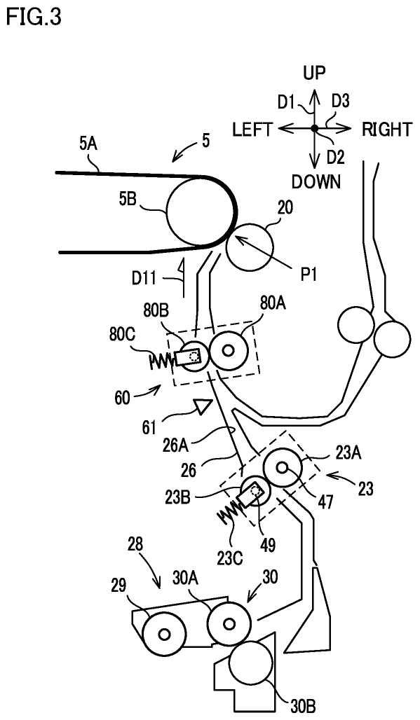

FIG. 3 is a schematic diagram showing a peripheral configuration of the conveying path 26. By receiving a rotational driving force from a conveying motor 56 (see FIG. 4), the pair of sheet feed rollers 30 convey a sheet toward a downstream side of a conveying direction D11. As shown in FIG. 3, the pair of sheet feed rollers 30 include a drive roller 30A that rotates when a rotational driving force is transmitted thereto from the conveying motor 56, and a driven roller 30B that is driven while being in contact with the drive roller 30A. A drive transmission mechanism (not shown) that transmits a rotation of the drive roller 30A to the pickup roller 29 is provided between the pickup roller 29 and the drive roller 30A. The pickup roller 29 and the drive roller 30A are coupled via the drive transmission mechanism. When the drive roller 30A is rotated by the conveying motor 56, the pickup roller 29 is also rotated in the same direction and at the same peripheral speed as the drive roller 30A by the drive transmission mechanism.

When an instruction signal to start a sheet feed operation is input to the image forming apparatus 10, the pickup roller 29 and the pair of sheet feed rollers 30 are rotated by the rotational driving force of the conveying motor 56, and a sheet is fed from the sheet storing portion 27 to the conveying path 26. Specifically, a sheet in the sheet storing portion 27 is extracted to be fed toward a downstream side of a sheet feed direction by the pickup roller 29, and when a tip end portion of that sheet reaches a nip portion of the pair of sheet feed rollers 30, the sheet is conveyed to the conveying path 26 by the pair of sheet feed rollers 30.

The conveying path 26 is a guiding path that guides the sheet fed by the pair of sheet feed rollers 30 toward the sheet discharge outlet 15A. As shown in FIG. 2, the conveying path 26 extends upwardly after being bent upwardly from the pair of sheet feed rollers 30, and reaches the sheet discharge outlet 15A via the secondary transfer roller 20.

As shown in FIG. 3, the sheet conveying unit 23 and the sheet correction mechanism 60 are provided on the conveying path 26.

The sheet conveying unit 23 conveys a sheet fed to the conveying path 26 by the sheet feed unit 28 in the conveying direction D11 directed toward an image transfer position P1 (see FIG. 3). The image transfer position P1 is a position at which a drive roller 5B and the secondary transfer roller 20 oppose each other. By receiving a rotational driving force from the conveying motor 56 (see FIG. 4), the sheet conveying unit 23 conveys the sheet toward the downstream side of the conveying direction D11. The configuration of the sheet conveying unit 23 will be described later.

On the conveying path 26, the sheet correction mechanism 60 is arranged on an upstream side of the image transfer position P1 in the conveying direction D11 and on the downstream side of the sheet conveying unit 23 in the conveying direction D11. The sheet correction mechanism 60 conveys, while correcting an orientation and position of a sheet that is conveyed on the conveying path 26 in a state where the sheet is deviated in an intersecting direction that intersects with the conveying direction D11, the sheet toward the downstream side of the conveying direction D11. A conveyance deviation of a sheet is a tilt with respect to the conveying direction D11, a lateral deviation in a width direction orthogonal to the conveying direction D11, and the like. The configuration of the sheet correction mechanism 60 will be described later.

As shown in FIG. 2, each of the image forming units 4 is provided below the intermediate transfer unit 5. Each image forming unit 4 carries out image forming processing for forming a toner image on a surface of a transfer belt 5A based on image data input from outside. The plurality of image forming units 4 are arranged along a traveling direction of the transfer belt 5A (a direction indicated by arrows D10). Sequentially from the left side to the right side of the transfer belt 5A, an image forming unit 4Y for yellow, an image forming unit 4C for cyan, an image forming unit 4M for magenta, and an image forming unit 4K for black are arranged in line in the stated order.

Each of the image forming units 4 includes a photoconductor drum 41, a charging device 42, a developing device 44, a primary transfer roller 45, and the like. The image forming unit 4Y forms a toner image on a surface of the photoconductor drum 41 using yellow toner. The image forming unit 4C, the image forming unit 4M, and the image forming unit 4K form toner images on the surfaces of the photoconductor drums 41 using cyan toner, magenta toner, and black toner, respectively. Developing processing of the toner image with respect to the photoconductor drum 41 is carried out by the developing device 44.

The intermediate transfer unit 5 includes the transfer belt 5A, the drive roller 5B, and a driven roller 5C. The transfer belt 5A is a belt member onto which toner images of the respective colors, that are formed on the photoconductor drums 41 of the respective image forming units 4, are transferred. The transfer belt 5A is provided on an upper side of the photoconductor drums 41. The transfer belt 5A is an endless annular belt. The transfer belt 5A is rotatably supported by the drive roller 5B and the driven roller 5C that are provided apart from each other in the left-right direction D3. The transfer belt 5A is supported while being bridged between the drive roller 5B and the driven roller 5C. When the surface of the transfer belt 5A passes between the photoconductor drums 41 and the primary transfer rollers 45, toner images are sequentially transferred from the respective photoconductor drums 41 onto the transfer belt 5A while overlapping one another.

The laser scanning unit 13 irradiates laser light onto the photoconductor drums 41 of the image forming units 4 based on input image data of the respective colors. Thus, an electrostatic latent image is formed on each of the photoconductor drums 41.

The secondary transfer roller 20 is provided opposed to the drive roller 5B so as to sandwich the conveying path 26 extending longitudinally. The secondary transfer roller 20 carries out transfer processing for transferring the toner images on the transfer belt 5A onto a sheet by a transfer potential applied to the secondary transfer roller 20. The sheet onto which the toner images are transferred is conveyed to the fixing device 16.

The fixing device 16 heats the toner images transferred onto the sheet and fixes the toner images onto the sheet. The fixing device 16 includes a heating roller 16A and a pressure roller 16B. The sheet conveyed to the fixing device 16 is nipped by the heating roller 16A and the pressure roller 16B to be conveyed. During this conveyance, heat from the heating roller 16A is transmitted to the toner images transferred onto the sheet to thus heat the toner images. Thus, the toner images are fixed to the sheet. After that, the sheet is discharged to the sheet tray 18 by the sheet discharge portion 15.

[Sheet Conveying Unit 23]

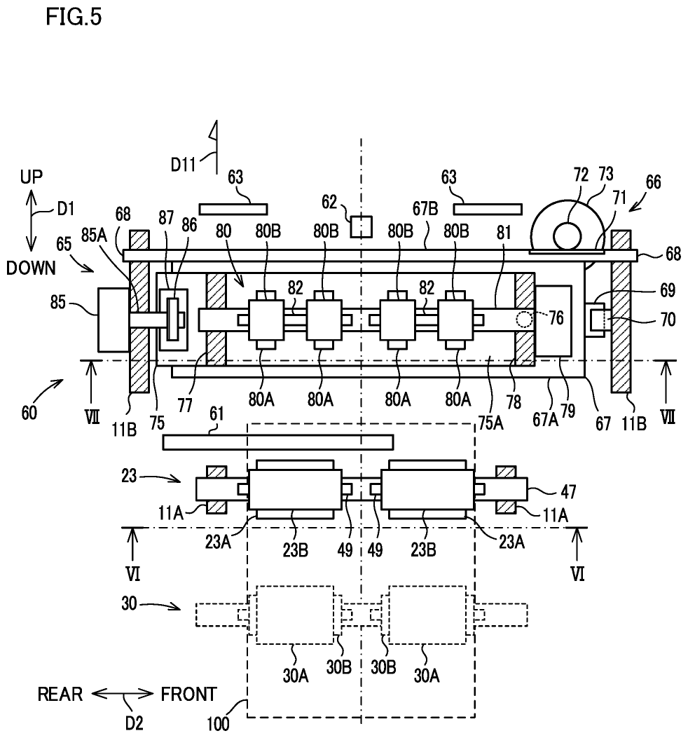

As shown in FIG. 3, the sheet conveying unit 23 includes a drive roller 23A that is rotationally driven when applied with a driving force from the conveying motor 56 (see FIG. 5) and a driven roller 23B that is arranged in contact with an outer circumferential surface of the drive roller 23A. A pair of conveying rollers are realized by the drive roller 23A and the driven roller 23B.

FIG. 5 shows the sheet conveying unit 23. As shown in FIG. 5, the sheet conveying unit 23 includes two drive rollers 23A arranged at regular intervals along the front-rear direction D2 orthogonal to the conveying direction D11. Hereinafter, the front-rear direction D2 may be referred to as a width direction D2. Each of the drive rollers 23A is fixed to a rotation shaft 47 extending in the width direction D2, and this rotation shaft 47 is rotatably supported by an internal frame 11A of the housing 11. A driving force from the conveying motor 56 (see FIG. 4) is transmitted to the rotation shaft 47. The driving force of the conveying motor 56 is transmitted to the rotation shaft 47 via a transmission mechanism (not shown) such as a gear and a belt.

In addition, the sheet conveying unit 23 includes two driven rollers 23B respectively corresponding to the drive rollers 23A. The drive roller 23A and the driven roller 23B constitute the pair of conveying rollers. In other words, the sheet conveying unit 23 includes two pairs of conveying rollers arranged in the width direction D2. Two rotation shafts 49 are provided in a guide member 26A (see FIG. 3) constituting a conveying guide surface on the left side of the conveying path 26. The two driven rollers 23B are rotatably supported by the respective rotation shafts 49. The rotation shafts 49 are provided apart from each other in the width direction D2, and one driven roller 23B is rotatably supported by one rotation shaft 49.

As shown in FIG. 3, the driven roller 23B is biased toward the drive roller 23A side by a predetermined elastic force (spring force) of a spring 23C. Thus, the driven roller 23B is pressed against the drive roller 23A. When the drive roller 23A is rotationally driven in this state, the driven roller 23B is driven.

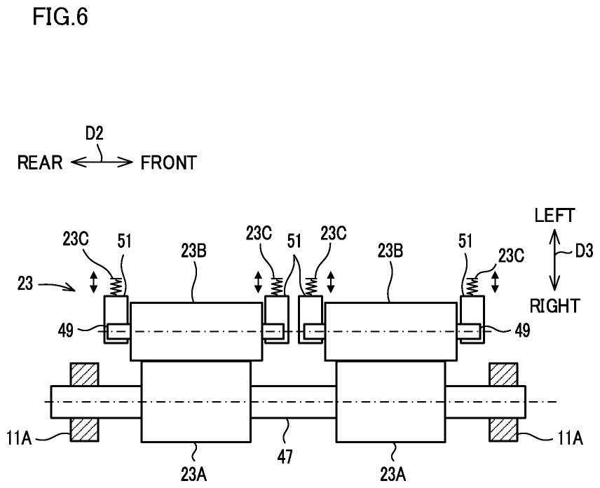

FIG. 6 is a schematic diagram showing a configuration of the sheet conveying unit 23, and shows a case where the sheet conveying unit 23 is seen from the upstream side of the conveying direction D11 (see arrows VI) in FIG. 5. As shown in FIG. 6, the rotation shafts 49 of the driven rollers 23B are supported by supporting portions 51 provided in the guide member 26A (see FIG. 3). Shaft end portions of the rotation shafts 49 are respectively supported by the supporting portions 51.

In the guide member 26A (see FIG. 3), the supporting portions 51 are supported while being movable in the up-down direction D1. In this embodiment, the supporting portions 51 support the driven rollers 23B such that the driven rollers 23B are movable between a contact position (position shown in FIG. 6) to be described later and a releasing position to be described later. In other words, the driven rollers 23B are supported while being movable between the contact position and the releasing position.

The supporting portions 51 are biased downwardly by the springs 23C. In other words, the supporting portions 51 support the shaft end portions of the rotation shafts 49 while biasing the shaft end portions downwardly by the spring force of the springs 23C.

In a state where the supporting portions 51 are arranged at the contact position shown in FIG. 6, the driven rollers 23B are elastically biased toward the drive rollers 23A side by a predetermined spring force (elastic force) of the springs 23C. Thus, the drive rollers 23A and the driven rollers 23B are pressed against each other by the spring force. This spring force is an elastic force large enough to enable a sheet to be nipped and conveyed in the conveying direction D11.

When the supporting portions 51 are raised upwardly from the contact position and moved to the releasing position, the state where the driven rollers 23B are pressed against the drive rollers 23A is released. In other words, the releasing position is a position at which the driven rollers 23B are set apart from the drive rollers 23A to thus release the pressing with respect to the drive rollers 23A. It is to be noted that the releasing position will be described as the position at which the driven rollers 23B are set apart from the drive rollers 23A, but the releasing position may be a position at which surfaces of the driven rollers 23B and surfaces of the drive rollers 23A are in contact with each other as long as a sheet cannot be nipped and conveyed. In other words, the releasing position includes a position at which the surfaces of the driven rollers 23B and the surfaces of the drive rollers 23A are in contact with each other in a level at which a conveying force by the driven rollers 23B and the drive rollers 23A is not transmitted to the sheet. Such a contact state is a state where the pressing state is released.

FIG. 4 is a block diagram showing a configuration of the image forming apparatus 10. As shown in FIG. 4, a solenoid 64 is provided inside the housing 11. The solenoid 64 is connected to the control portion 90 and operates by being energized by the control portion 90. A plunger of the solenoid 64 is coupled to the supporting portions 51 via a link member (not shown). When the solenoid 64 is energized, the plunger is operated so as to move the supporting portions 51 from the contact position to the releasing position. Then, when the solenoid 64 is de-energized, the plunger returns to its original position by a tension spring provided in the solenoid 64, with the result that the supporting portions 51 are caused to return to the contact position by the spring force of the springs 23C.

As shown in FIG. 3, a deviation detection sensor 61 (an example of a detection portion of the present disclosure) is provided on the conveying path 26. The deviation detection sensor 61 detects a conveyance deviation of a sheet conveyed on the conveying path 26. When a sheet is conveyed while being tilted with respect to the conveying direction D11, the deviation detection sensor 61 acquires information indicating a tilted state (tilt information) including whether or not there is a tilt, a direction of the tilt, a tilt amount (tilt angle), and the like. On the conveying path 26, the deviation detection sensor 61 is provided on the downstream side of the sheet conveying unit 23 in the conveying direction D11 and on the upstream side of the sheet correction mechanism 60 in the conveying direction D11.

As shown in FIG. 5, the deviation detection sensor 61 is a line sensor that extends in the width direction D2. The line sensor is constituted of a plurality of image sensors arranged in line along the width direction D2. The deviation detection sensor 61 is connected to the control portion 90. The deviation detection sensor 61 outputs a detection signal including image data (concentration data) of a tip end of a sheet to the control portion 90. Upon acquiring the detection signal from the deviation detection sensor 61, the control portion 90 carries out various determinations based on that detection signal. Specifically, the control portion 90 carries out, based on the detection signal, processing of determining whether or not a sheet conveyed by the sheet conveying unit 23 is tilted with respect to the conveying direction D11, and when the sheet is tilted, processing of determining a direction of the tilt. In addition, the control portion 90 determines a tilt amount (tilt angle) of the sheet based on the tilt information. These determination techniques are well known from the past, so detailed descriptions thereof will be omitted.

It is to be noted that the deviation detection sensor 61 may be a pair of reflective optical sensors that are provided at positions set apart from each other at regular intervals in the width direction D2 from a center of the conveying path 26. The reflective optical sensor includes a light-emitting element and a light-receiving element, and receives reflected light of light emitted from the light-emitting element and outputs a detection signal corresponding to an amount of the light received. The control portion 90 carries out, based on a deviation of a change in the detection signal transmitted from each of the pair of reflective optical sensors, processing of determining whether or not a sheet conveyed by the sheet conveying unit 23 is tilted with respect to the conveying direction D11, and when the sheet is tilted, processing of determining a tilt direction thereof and processing of determining a tilt amount (tilt angle) of the sheet based on the tilt information.

On the conveying path 26, a tip end detection sensor 62 and an edge detection sensor 63 are provided on the downstream side of the sheet correction mechanism 60 in the conveying direction D11.

The tip end detection sensor 62 is provided near the center of the conveying path 26 in the width direction D2. The tip end detection sensor 62 detects a tip end of a sheet that has passed through the sheet correction mechanism 60. The tip end detection sensor 62 is, for example, a reflective optical sensor. The tip end detection sensor 62 is connected to the control portion 90, and a detection signal thereof is transmitted to the control portion 90. The control portion 90 detects a tip end of the sheet conveyed on the conveying path 26 based on a change of the detection signal transmitted from the tip end detection sensor 62. It is to be noted that such a detection technique is well known from the past, so detailed descriptions thereof will be omitted.

The edge detection sensor 63 (an example of the detection portion of the present disclosure) is arranged on the downstream side of the tip end detection sensor 62 in the conveying direction D11, and detects a conveyance deviation of the sheet conveyed on the conveying path 26. When the sheet is conveyed while being deviated laterally with respect to the width direction D2 orthogonal to the conveying direction D11, the edge detection sensor 63 acquires information indicating a lateral deviation state (lateral deviation information) including whether or not there is a lateral deviation, a deviation direction, a lateral deviation amount, and the like.

The edge detection sensor 63 detects both end positions of the sheet that has passed through the sheet correction mechanism 60, in the width direction D2. The edge detection sensor 63 includes a pair of line sensors provided at positions set apart from each other at regular intervals from the center of the conveying path 26 toward the outer sides in the width direction D2. Each of the line sensors is constituted of a plurality of image sensors arranged in line along the width direction D2. In this embodiment, the edge detection sensor 63 is arranged such that the end portions of the sheet in the width direction D2 pass through the respective line sensors.

The edge detection sensor 63 is connected to the control portion 90. The edge detection sensor 63 outputs a detection signal (concentration signal) including image data (concentration data) of the both end portions of the sheet to the control portion 90. Upon acquiring the detection signal from the edge detection sensor 63, the control portion 90 determines the position of the sheet in the width direction D2 based on that detection signal. Specifically, the control portion 90 determines whether or not the sheet is laterally deviated in the width direction D2, whether or not the sheet is deviated in either direction of the width direction D2, a level of a deviation amount (lateral deviation amount) of the sheet when the sheet is laterally deviated in the width direction D2, and the like. It is to be noted that such a determination technique is well known from the past, so detailed descriptions thereof will be omitted.

[Sheet Correction Mechanism 60]

As shown in FIG. 3, the sheet correction mechanism 60 is provided on the conveying path 26. On the conveying path 26, the sheet correction mechanism 60 is provided on the downstream side of the sheet conveying unit 23 in the conveying direction D11. Specifically, the sheet correction mechanism 60 is provided between the deviation detection sensor 61 and the tip end detection sensor 62 on the conveying path 26.

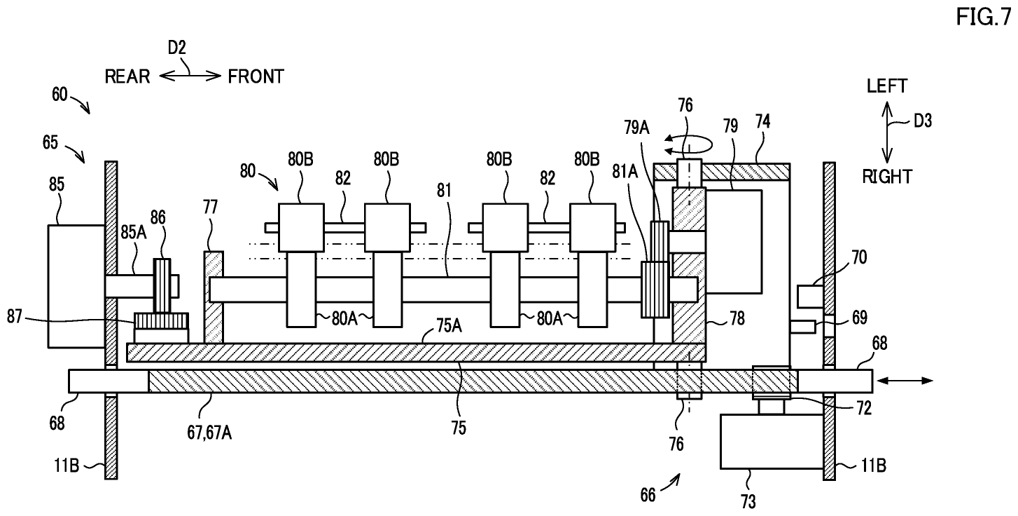

FIG. 7 is a schematic diagram showing a configuration of the sheet correction mechanism 60, and shows a case where the sheet correction mechanism 60 is seen from the upstream side of the conveying direction D11 (see arrows VII) in FIG. 5. When a conveyance deviation of a sheet is detected by the deviation detection sensor 61 or the edge detection sensor 63, the sheet correction mechanism 60 is displaced from a predetermined sheet acceptance position to a correction completion position to correct the conveyance deviation of the sheet. As shown in FIG. 7, the sheet correction mechanism 60 includes a rotation unit 65 (an example of a rotation unit of the present disclosure) and a slide unit 66 (an example of a slide unit of the present disclosure).

When a tilt (an example of the conveyance deviation) of a sheet is detected by the deviation detection sensor 61, the rotation unit 65 corrects the tilt of the sheet. In this embodiment, the rotation unit 65 corrects the tilt (an example of the conveyance deviation) of the sheet conveyed by the sheet conveying unit 23 while being tilted with respect to the conveying direction D11, and conveys the corrected sheet in the conveying direction D11. Specifically, before the sheet enters the sheet correction mechanism 60, the rotation unit 65 causes a roller unit 80 to rotate from a predetermined initial position to a sheet acceptance position at which the roller unit 80 accepts the sheet, only by a rotation amount corresponding to a tilt amount (tilt angle) of the tilt of the sheet. Then, after the sheet enters the rotation unit 65 at the sheet acceptance position, the rotation unit 65 causes the roller unit 80 to return from the sheet acceptance position to the initial position while nipping the sheet. Thus, the sheet is rotated from a position before the correction to a predetermined designated position, to correct the tilt of the sheet.

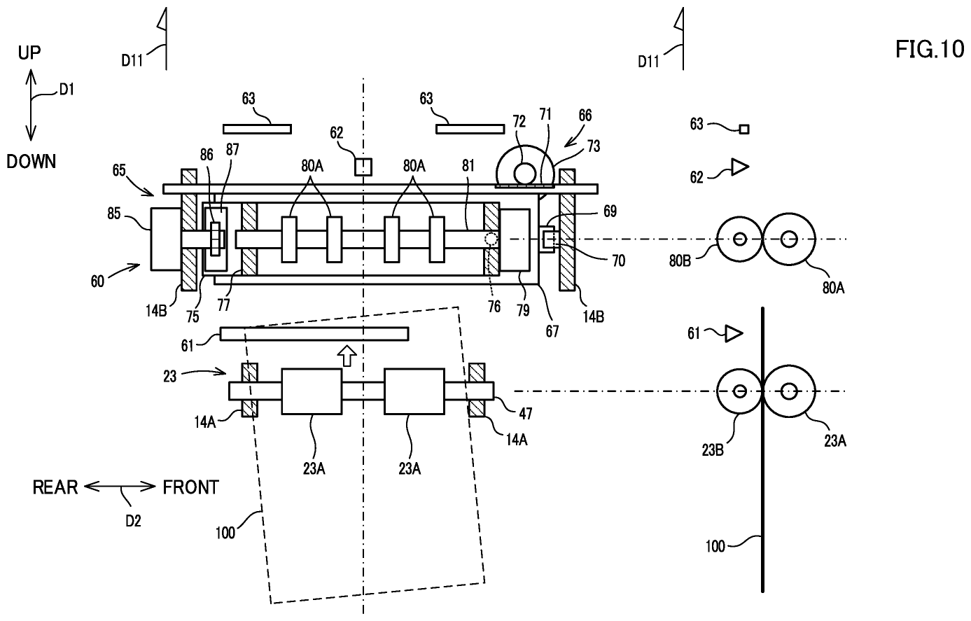

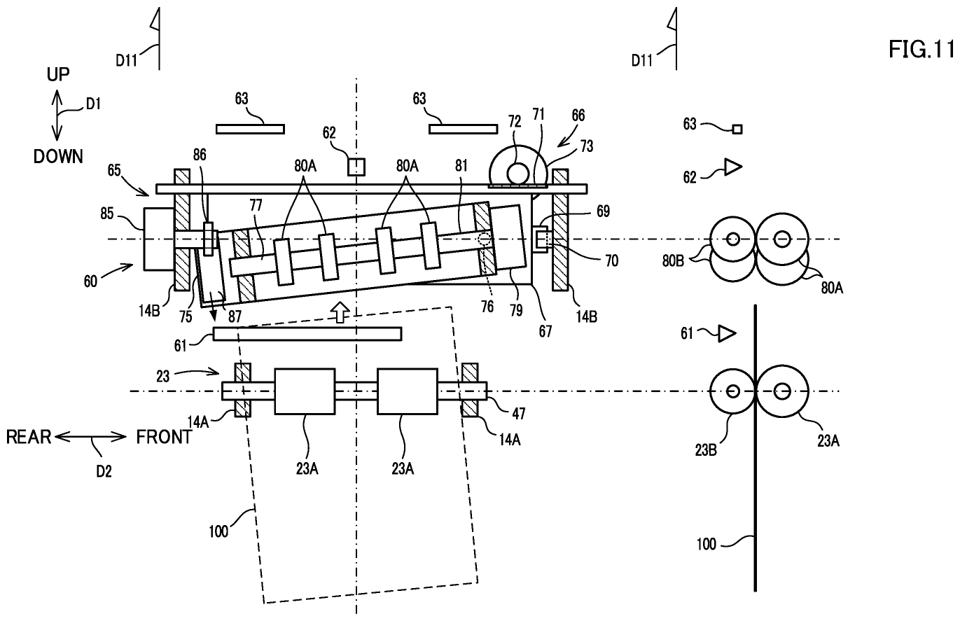

Here, the initial position is a position at which the sheet can be conveyed straight toward the downstream side of the conveying direction D11 by the roller unit 80 to be described later, and is a position at which a rotation shaft 81 of the roller unit 80 is arranged to be straight along the width direction D2 as shown in FIG. 10. Moreover, the sheet acceptance position is a position at which, when a first correction preparation operation to be described later is carried out, a sheet tilted at a first tilted attitude to be described later is rotated in a direction corresponding to a tilt direction of the sheet (the upstream side of the conveying direction D11), only by a rotation amount with which the sheet becomes straight with respect to the conveying direction D11, and is, for example, a position shown in FIG. 11. Further, the sheet acceptance position is a position at which, when a second correction preparation operation to be described later is carried out, a sheet tilted at a second tilted attitude to be described later is rotated in a direction corresponding to a tilt direction of the sheet (the downstream side of the conveying direction D11), only by a rotation amount with which the sheet becomes straight with respect to the conveying direction D11.

When a lateral deviation (an example of the conveyance deviation) of a sheet is detected by the edge detection sensor 63, the slide unit 66 corrects the lateral deviation of the sheet. In this embodiment, when the sheet conveyed by the sheet conveying unit 23 is deviated in the width direction D2, the slide unit 66 carries out correction so as to correct that lateral deviation to return to a predetermined center position. Specifically, after the sheet enters the slide unit 66, the slide unit 66 moves in a lateral deviation correction direction (a direction opposite to the lateral deviation direction) only by an amount corresponding to the lateral deviation amount of the sheet in the width direction D2, from a slide reference position to be described later, which is an initial position of the slide unit 66, while nipping the sheet. Thus, the sheet slides to a predetermined designated position from the position before the correction, and thus the lateral deviation of the sheet in the width direction D2 is corrected.

As shown in FIG. 5 and FIG. 7, the slide unit 66 includes a base frame 67 elongated in the width direction D2. The base frame 67 is movably supported by an internal frame 11B of the housing 11 so as to be movable in the width direction D2. Specifically, the base frame 67 includes a horizontal flat plate-like base portion 67A and a supporting portion 67B (see FIG. 5) integrally formed at an upper end portion of the base portion 67A. The supporting portion 67B includes shaft portions 68 protruding outwardly from both end portions of the base portion 67A in the width direction D2, and the supporting portion 67B is supported by inserting the shaft portions 68 into shaft holes formed in the internal frame 11B.

As shown in FIG. 5, a rack 71 is formed on a rear end surface of the supporting portion 67B. A pinion gear 72 interlocks with this rack 71. The slide unit 66 includes a second correction motor 73. The pinion gear 72 is attached to an output shaft of the second correction motor 73. Therefore, by controlling drive of the second correction motor 73, the control portion 90 can cause the base frame 67 of the slide unit 66 to slide in either direction (front direction or rear direction) of the width direction D2.

As shown in FIG. 5, a protrusion piece 69 protruding toward the front side is formed at a front end portion of the base frame 67. Moreover, an optical sensor 70 capable of sensing the protrusion piece 69 is provided in the front-side internal frame 11B. The optical sensor 70 senses a position of the protrusion piece 69. Using a position at which the optical sensor 70 senses the protrusion piece 69 (hereinafter, referred to as a slide reference position) as a reference, the control portion 90 moves the base frame 67 in the width direction D2.

In addition, a supporting portion 74 (see FIG. 7) for supporting a rotation shaft 76 (an example of a rotation fulcrum of the present disclosure) to be described later is provided near the front end portion of the base portion 67A.

As shown in FIG. 5 and FIG. 7, the rotation unit 65 includes a rotational frame 75 supported by the base portion 67A of the base frame 67, the roller unit 80 rotatably supported by the rotational frame 75, and a first correction motor 85 that applies a driving force in a rotation direction to the rotational frame 75. The rotational frame 75 is a plate-like member elongated in the width direction D2, and the rotation shaft 76 extending in the left-right direction D3 is provided at a front end portion thereof. The rotation shaft 76 is rotatably supported by the supporting portion 74 (see FIG. 7) provided in the base frame 67.

As shown in FIG. 7, a pair of supporting walls 77 and 78 are provided on a left surface 75A (an upper surface in the page of FIG. 7) of the rotational frame 75 while being apart from each other in the width direction D2 at a predetermined interval. The pair of supporting walls 77 and 78 protrude vertically toward the left side from the left surface 75A. The predetermined interval is a length with which a sheet can be conveyed between the pair of supporting walls 77 and 78. The roller unit 80 is rotatably supported by the supporting walls 77 and 78.

The roller unit 80 is rotationally driven by the third correction motor 79. The roller unit 80 conveys the sheet that has entered the sheet correction mechanism 60 toward the downstream side of the conveying direction D11. The roller unit 80 includes drive rollers 80A that are rotated by a rotational driving force from the third correction motor 79 and driven rollers 80B that are provided while being in contact with outer circumferential surfaces of the drive rollers 80A. The drive roller 80A and the driven roller 80B realize a pair of conveying rollers. This pair of conveying rollers are an example of a correction roller of the present disclosure.

The roller unit 80 includes four drive rollers 80A arranged at regular intervals along the width direction D2. The respective drive rollers 80A are fixed to a rotation shaft 81 extending in the width direction D2, and this rotation shaft 81 is rotatably supported by the supporting walls 77 and 78. The third correction motor 79 is fixed to the supporting wall 78. A rotational driving force of the third correction motor 79 is transmitted to the rotation shaft 81 via an output gear 79A fixed to an output shaft of the third correction motor 79 and an input gear 81A fixed to an end portion of the rotation shaft 81. The roller unit 80 also includes four driven rollers 80B respectively corresponding to the drive rollers 80A. The four driven rollers 80B are respectively rotatably supported by rotation shafts 82 provided in a guide member constituting a conveying guide surface on an upper side of the conveying path 26. Two rotation shafts 82 are provided while being apart from each other in the width direction D2, and two driven rollers 80B are rotatably supported by each of the rotation shafts 82.

The driven rollers 80B are biased toward the drive rollers 80A by springs 80C (see FIG. 3). Thus, the driven rollers 80B are pressed against the drive rollers 80A. The driven rollers 80B are driven when the drive rollers 80A are rotationally driven in this state.

The first correction motor 85 is attached to the rear-side internal frame 11B. The first correction motor 85 is fixed to an outer surface of the internal frame 11B, and an output shaft 85A of the first correction motor 85 penetrates through the internal frame 11B and extends to the other side (front side). A pinion gear 86 is fixed to a tip end of the output shaft 85A of the first correction motor 85. A rack 87 extending in the up-down direction D1 (a direction vertical to the page of FIG. 7) is formed at a rear end portion of the left surface 75A of the rotational frame 75. The rack 87 interlocks with the pinion gear 86. The rack 87 includes parallel teeth arranged in the up-down direction D1. The control portion 90 controls drive of the first correction motor 85 to thus cause the roller unit 80 to rotate about the rotation shaft 76 together with the rotational frame 75 of the rotation unit 65.

In this embodiment, when a tilted attitude of the sheet conveyed while being tilted with respect to the conveying direction D11 is the first tilted attitude (first attitude), the rotation unit 65 carries out the first correction preparation operation for causing the roller unit 80 to rotate from the initial position toward the upstream side of the conveying direction D11. Here, the first tilted attitude is a tilted state where a front end portion of the sheet precedes a rear end portion, and is an attitude as indicated by a broken line in FIG. 10. Alternatively, when a tilted attitude of a sheet conveyed in a tilted state is a second tilted attitude (second attitude) tilted in a direction opposite to the first tilted attitude, the rotation unit 65 carries out the second correction preparation operation for causing the roller unit 80 to rotate from the initial position toward the downstream side of the conveying direction D11. Here, the second tilted attitude is a tilted state where a rear end portion of the sheet precedes a front end portion.

[Control Portion 90]

The control portion 90 collectively controls the image forming apparatus 10, controls operations of the sheet conveying unit 23 and operations of the sheet correction mechanism 60, and controls a conveying speed by the respective pairs conveying rollers. As shown in FIG. 4, the control portion 90 is constituted of a CPU 91, a ROM 92, a RAM 93, a flash memory 94, a motor driver 95, and the like. The control portion 90 is an example of a speed control portion of the present disclosure. The control portion 90 is electrically connected to the respective motors 56, 73, 79, and 85, the respective sensors 61, 62, and 63, and the solenoid 64 via a signal line and the like. It is to be noted that the respective motors 56, 73, 79, and 85 are connected to the motor driver 95 of the control portion 90, and drive thereof is controlled upon receiving individual control signals from the motor driver 95.

Incidentally, when the roller unit 80 of the rotation unit 65, the slide unit 66, or the like is rotated at a predetermined setting speed in correcting a sheet by the sheet correction mechanism 60, the units 80 and 66 may oscillate in a displacement direction at a time of stopping the rotation. In this case, when the sheet is conveyed in the conveying direction D11 and reaches the image transfer position P1 in a state where the oscillation is not settled, an image is transferred onto the oscillating sheet, thus resulting in a problem that image quality is lowered. On the other hand, when a sheet conveying speed is lowered so that the oscillation falls below a standard or conveyance of a sheet is temporarily stopped, a first print time as a time required from when an image forming instruction is input to when the sheet is discharged becomes long. Moreover, when a distance between the correction position and the image transfer position P1 is increased so that the oscillation falls below the standard, there arises a problem that an apparatus size becomes large in the conveying direction D11 in addition to the prolonging of the first print time.

As will be described later, in this embodiment, during a rotation process in which the roller unit 80 rotates from the sheet acceptance position to the initial position, the control portion 90 changes the rotation speed (displacement speed) from a preset first rotation speed V1 (an example of a first speed of the present disclosure) to a second rotation speed V2 (an example of a second speed of the present disclosure) lower than the first rotation speed V1. In other words, the control portion 90 causes the roller unit 80 to rotate at the first rotation speed V1, and thereafter causes it to rotate at the second rotation speed V2. The second rotation speed V2 is set to be about 50% of the first rotation speed V1, for example. It is to be noted that a deceleration rate of the second rotation speed V2 to the first rotation speed V1 is not limited to 50%.

Further, during a sliding process in which the slide unit 66 slides from the slide reference position in a direction in which a lateral deviation can be corrected, the control portion 90 changes the sliding speed (displacement speed) from a preset first sliding speed V11 (an example of the first speed of the present disclosure) to a second sliding speed V12 (an example of the second speed of the present disclosure) lower than the first sliding speed V11. In other words, the control portion 90 causes the slide unit 66 to slide at the first sliding speed V11, and thereafter causes it to slide at the second sliding speed V12. The second sliding speed V12 is set to be about 50% of the first sliding speed V11, for example. It is to be noted that a deceleration rate of the second sliding speed V12 to the first sliding speed V11 is not limited to 50%.

As described above, since the roller unit 80 or the slide unit 66 is decelerated during the sheet correction operation, it is possible to suppress oscillation of the corrected sheet as well as improve accuracy in correcting a conveyance deviation of a sheet.

[Sheet Correction Processing]

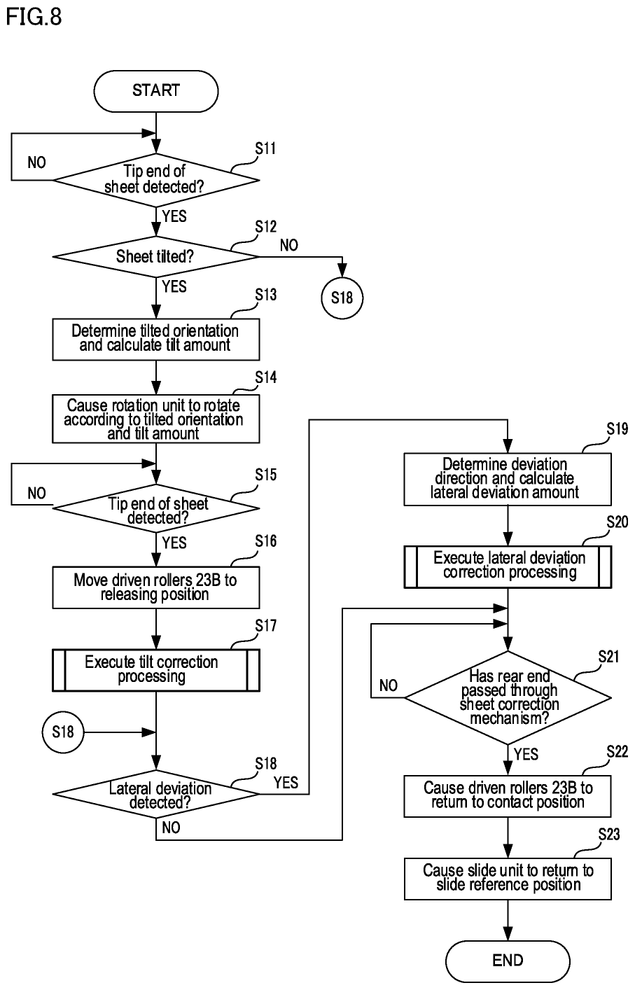

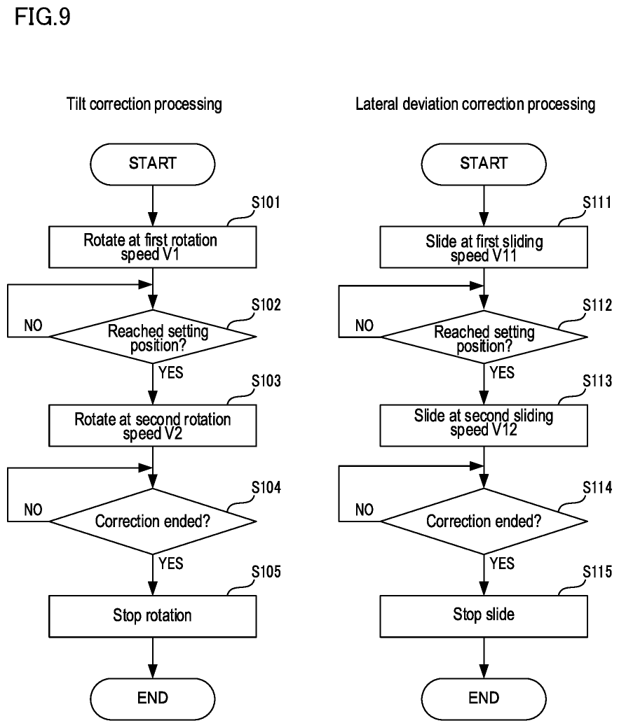

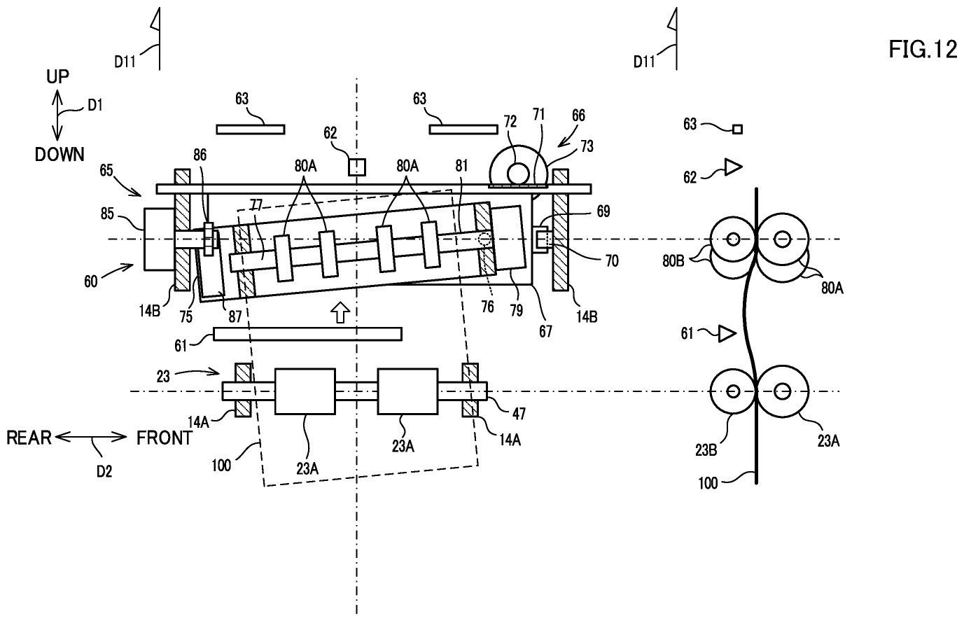

Hereinafter, exemplary procedures of sheet correction processing executed by the control portion 90 will be described using flowcharts shown in FIG. 8 and FIG. 9 with reference to operational explanatory diagrams shown in FIG. 10 to FIG. 15. Here, FIG. 10 to FIG. 15 are diagrams for explaining the operations of the sheet conveying unit 23 and the sheet correction mechanism 60, in each of which a diagram on the left side of the page is a diagram seen from a direction vertical to the conveying direction D11, and a diagram on the right side is a diagram seen from an axial direction of the respective drive rollers 23A and 80A. In FIG. 10 to FIG. 15, an illustration of the pair of sheet feed rollers 30 is omitted.

It is to be noted that in the image forming apparatus 10, it is assumed that, before the sheet correction processing is carried out, the roller unit 80 of the rotation unit 65 is arranged at the initial position, and the slide unit 66 is arranged at the slide reference position.

When an instruction signal that instructs to start an image forming operation is input to the image forming apparatus 10, image forming processing by the image forming apparatus 10 is started. Specifically, the motor driver 95 of the control portion 90 drives the conveying motor 56, the third correction motor 79, other motors (not shown), and the like to cause the drive rollers 30A of the pair of sheet feed rollers 30, the pickup roller 29, the drive rollers 23A of the sheet conveying unit 23, the drive rollers 80A of the roller unit 80, the pair of discharge rollers, and the like to rotate. Thus, a sheet 100 is taken out from the sheet storing portion 27 to be fed to the conveying path 26, and the sheet 100 is further conveyed by the pair of sheet feed rollers 30 and the sheet conveying unit 23 toward the downstream side of the conveying direction D11. At this time, the control portion 90 controls the respective motors so that the conveying speed of the sheet 100 becomes a reference speed V₀. Here, the reference speed V₀ is a speed at which the sheet 100 is conveyed during transfer by the secondary transfer roller 20.

In Step S11, the control portion 90 determines whether or not a tip end of the sheet 100 has been detected based on the detection signal output from the deviation detection sensor 61. In other words, the control portion 90 determines whether or not a tip end of the sheet 100 has passed through a detection position by the deviation detection sensor 61.

When determined in Step S11 that the tip end of the sheet 100 has been detected at the detection position by the deviation detection sensor 61 (see FIG. 10), the control portion 90 determines whether or not the sheet 100 conveyed on the conveying path 26 is tilted with respect to the conveying direction D11 based on the detection signal from the deviation detection sensor 61 (S12). This determination processing is carried out before the tip end of the sheet 100 enters the sheet correction mechanism 60.

When determined in Step S12 that the sheet 100 is tilted, in the next Step S13, the control portion 90 determines a tilted attitude of the sheet 100 and calculates a tilt amount thereof based on an output signal from the deviation detection sensor 61. On the other hand, when determined in Step S12 that the sheet 100 is not tilted, the control portion 90 advances to Step S18.

After that, in Step S14, the control portion 90 controls drive of the first correction motor 85 to cause, before the sheet 100 enters the sheet correction mechanism 60, the roller unit 80 of the rotation unit 65 to rotate from the initial position to the sheet acceptance position at which tilt correction is to be started (see FIG. 11) in accordance with the tilt amount. Specifically, the roller unit 80 is rotated from the initial position to the sheet acceptance position in a direction opposite to the direction in which the sheet 100 is tilted, only by the tilt amount.

For example, as shown in FIG. 11, when the sheet 100 is conveyed in the first tilted attitude, the rotation unit 65 carries out the first correction preparation operation for causing the roller unit 80 to rotate from the initial position toward the upstream side of the conveying direction D11 (a direction of approaching the tip end portion of the sheet 100).

Alternatively, for example, when the sheet 100 is conveyed in the second tilted attitude (not shown), the rotation unit 65 carries out the second correction preparation operation for causing the roller unit 80 to rotate from the initial position toward the downstream side of the conveying direction D11 (a direction that moves away from the tip end portion of the sheet 100).

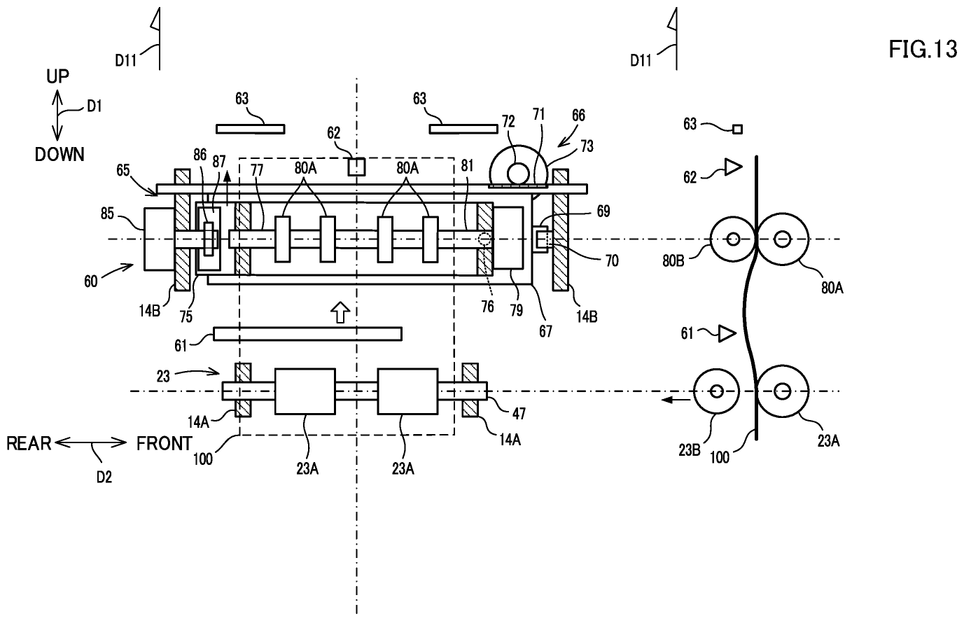

When the tip end of the sheet 100 reaches the tip end detection sensor 62 and the tip end of the sheet 100 is detected by the tip end detection sensor 62 (S15), the control portion 90 controls the solenoid 64 to move the driven rollers 23B to the releasing position in Step S16 (see FIG. 13).

After that, in Step S17, the control portion 90 carries out processing of causing the roller unit 80 of the rotation unit 65 to return from the sheet acceptance position to the initial position (tilt correction processing) (see FIG. 13). In other words, the control portion 90 causes the roller unit 80 to rotate only by an amount corresponding to the tilt amount in a direction opposite to the rotation direction of Step S14. Thus, the tilt of the sheet 100 is corrected.

For example, when the first correction preparation operation is carried out in Step S14, the control portion 90 causes the roller unit 80 to rotate toward the downstream side of the conveying direction D11 (the direction that moves away from the tip end portion of the sheet 100) to cause it to return from the sheet acceptance position to the initial position. Alternatively, when the second correction preparation operation is carried out in Step S14, the control portion 90 causes the roller unit 80 to rotate toward the upstream side of the conveying direction D11 (the direction of approaching the tip end portion of the sheet 100) to cause it to return from the sheet acceptance position to the initial position.

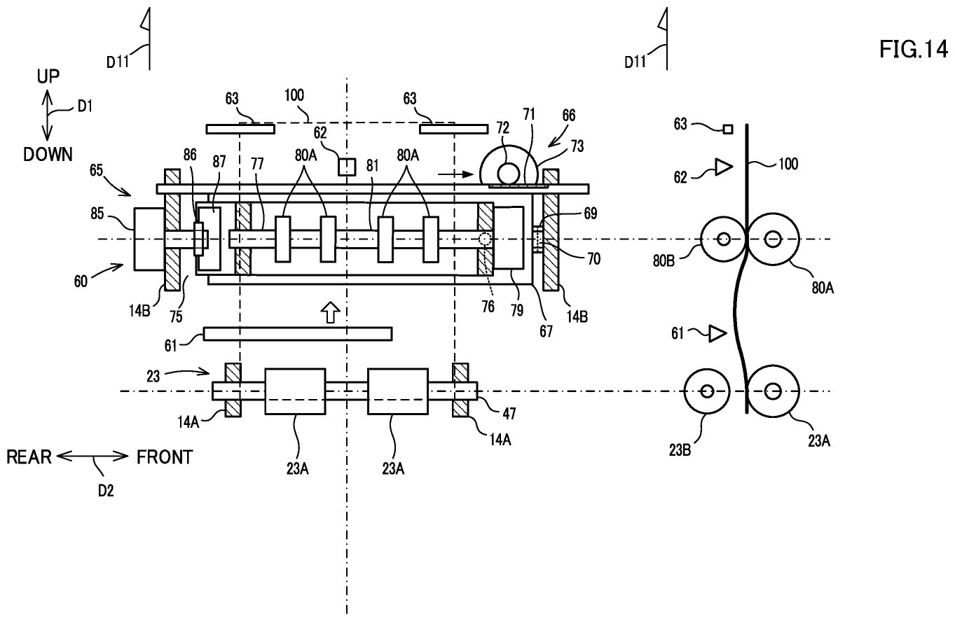

As shown in FIG. 14, when the tip end of the sheet 100 reaches the edge detection sensor 63, in the next Step S18, the control portion 90 determines whether or not the sheet 100 is deviated in either direction (front side or rear side) of the width direction D2 based on a detection signal from the edge detection sensor 63. Here, when there is a lateral deviation in the width direction D2, the processing advances to Step S19 so as to determine a lateral deviation direction and obtain a lateral deviation amount thereof. On the other hand, when there is no lateral deviation, the processing advances to Step S21.

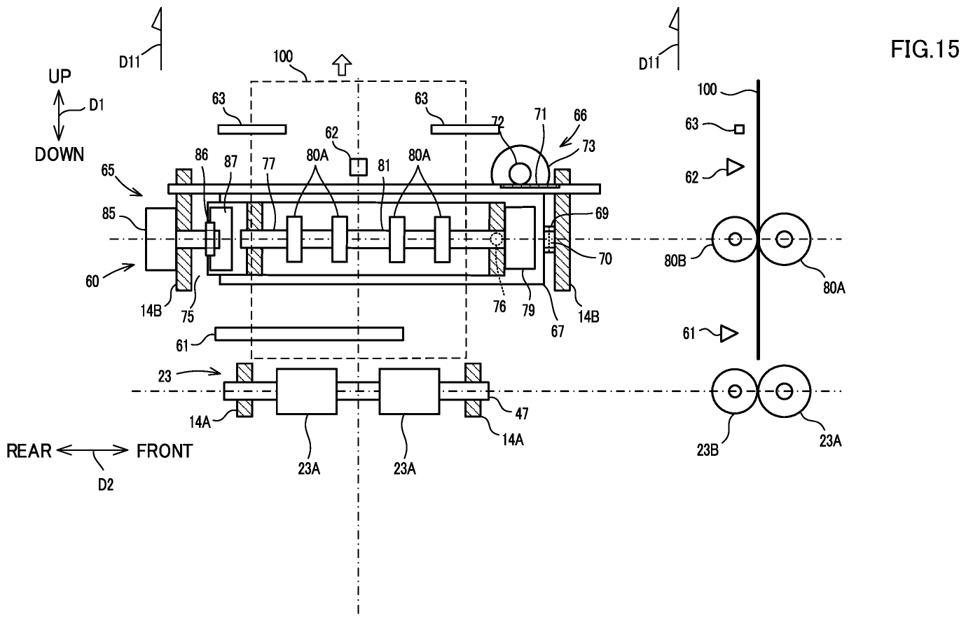

In Step S19, the control portion 90 determines the lateral deviation direction of the sheet 100 and calculates the lateral deviation amount thereof. After that, in Step S20, the control portion 90 carries out processing of causing the slide unit 66 to slide in a slide correction direction (see arrows in FIG. 14) according to the lateral deviation amount (lateral deviation correction processing). Specifically, the control portion 90 controls drive of the second correction motor 73 to cause the slide unit 66 to move from the slide reference position in a direction opposite to the lateral deviation direction of the sheet 100 only by the lateral deviation amount. Thus, the lateral deviation of the sheet 100 is corrected (see FIG. 15). After the slide movement of Step S20 is carried out, the processing advances to Step S21.

In Step S21, the control portion 90 determines whether or not a rear end of the sheet 100 has passed through the sheet correction mechanism 60. Then, when determined that the rear end of the sheet 100 has passed through the sheet correction mechanism 60, the control portion 90 causes the driven rollers 23B to move from the releasing position to the contact position (S22), and cases the slide unit 66 to return to the slide reference position (S23). Upon ending the image forming processing on the sheet, the control portion 90 stops the drive of the respective motors 56, 73, 79, and 85, and ends the series of processing.

Subsequently, with reference to FIG. 9, descriptions will be given on processing procedures in speed control executed during the tilt correction processing of Step S17 and speed control executed during the lateral deviation correction processing of Step S20. Here, FIG. 9 is a flowchart showing exemplary procedures of the speed control in the tilt correction processing and the lateral deviation correction processing executed by the control portion 90.

As shown in FIG. 9, when carrying out the tilt correction processing, the control portion 90 first controls, in a rotation process in which the roller unit 80 is rotated from the sheet acceptance position to the initial position, drive of the first correction motor 85 to cause the roller unit 80 to rotate at the first rotation speed V1 (S101).

In the next Step S102, the control portion 90 determines whether or not the roller unit 80 rotated at the first rotation speed V1 has reached a predetermined setting position. The setting position is a position set between the sheet acceptance position and the initial position as a correction completion position of the rotation unit 65.

In this embodiment, the setting position only needs to be a position set apart on the initial position side from a center position between the sheet acceptance position and the initial position. More preferably, the setting position is a position set apart on the initial position side from the sheet acceptance position, by a distance obtained by multiplying a distance between the sheet acceptance position and the initial position by a setting ratio exceeding 50%. It is to be noted that the setting ratio is not limited to 50% and only needs to be a ratio exceeding 50%. For example, the setting ratio is preferably a ratio determined within a range of 70% or more and smaller than 100%, more preferably a ratio determined within a range of 80% or more and smaller than 90%.

When determined in Step S102 that the roller unit 80 has reached the setting position, the control portion 90 controls drive of the first correction motor 85 to cause the roller unit 80 to rotate at the second rotation speed V2 (S103). In other words, the control portion 90 decelerates the rotation speed of the roller unit 80 from the first rotation speed V1 to the second rotation speed V2 at the setting position.

In the next Step S104, the control portion 90 determines whether or not the roller unit 80 has reached the initial position, and when the roller unit 80 has reached the initial position, determines that the correction has ended. After that, the drive of the first correction motor 85 is stopped.

As described above, in this embodiment, during the rotation process in which the roller unit 80 rotates from the sheet acceptance position to the initial position, the rotation speed of the roller unit 80 is decelerated from the first rotation speed V1 to the second rotation speed V2 at the setting position. At this time, although a brake effect by the deceleration acts on the roller unit 80, since the roller unit 80 is rotated at the second rotation speed V2, an oscillation does not occur in the roller unit 80. Moreover, although an oscillation in the rotation direction may be caused due to inertia at stoppage or the like when stopping the roller unit 80, since the roller unit 80 is decelerated to the second rotation speed V2, such an oscillation becomes markedly smaller than a case where the roller unit 80 is stopped in a state where it is rotated at the first rotation speed V1. As a result, it is possible to effectively suppress an oscillation of the sheet that has been subjected to the tilt correction.

As shown in FIG. 9, when carrying out the lateral deviation correction processing, the control portion 90 first controls, in a sliding process in which the slide unit 66 slides from the slide reference position to the correction completion position, drive of the second correction motor 73 to cause the slide unit 66 to slide at the first sliding speed V11 (S111). Here, the correction completion position is a position set apart from the slide reference position in the lateral deviation direction only by the lateral deviation amount calculated in Step S19.

In the next Step S112, the control portion 90 determines whether or not the slide unit 66 that is sliding at the first sliding speed V11 has reached a predetermined setting position. The setting position is a position set between the slide reference position and the correction completion position of the slide unit 66.

In this embodiment, the setting position only needs to be a position set apart on the correction completion position side from a center position between the slide reference position and the correction completion position. More preferably, the setting position is a position set apart on the correction completion position side from the slide reference position, by a distance obtained by multiplying a distance between the slide reference position and the correction completion position by a setting ratio exceeding 50%. It is to be noted that the setting ratio is not limited to 50% and only needs to be a ratio exceeding 50%. For example, the setting ratio is preferably a ratio determined within a range of 70% or more and smaller than 100%, more preferably a ratio determined within a range of 80% or more and smaller than 90%.

When determined in Step S112 that the slide unit 66 has reached the setting position, the control portion 90 controls drive of the second correction motor 73 to cause the slide unit 66 to slide at the second sliding speed V12 (S113). In other words, the control portion 90 decelerates the sliding speed of the slide unit 66 from the first sliding speed V11 to the second sliding speed V12 at the setting position.

In the next Step S114, the control portion 90 determines whether or not the slide unit 66 has reached the correction completion position, and when the slide unit 66 has reached the correction completion position, determines that the correction has ended. After that, the drive of the second correction motor 73 is stopped.

As described above, in this embodiment, during the sliding process in which the slide unit 66 slides from the slide reference position to the correction completion position at which the lateral deviation correction is ended, the sliding speed of the slide unit 66 is decelerated from the first sliding speed V11 to the second sliding speed V12 at the setting position. At this time, although a brake effect by the deceleration acts on the slide unit 66, since the slide unit 66 is sliding at the second sliding speed V12, an oscillation does not occur in the slide unit 66. Moreover, although an oscillation in the sliding direction may be caused due to inertia at stoppage or the like when stopping the slide unit 66, since the slide unit 66 is decelerated to the second sliding speed V12, such an oscillation becomes markedly smaller than a case where the slide unit 66 is stopped in a state where it is sliding at the first sliding speed V11. As a result, it is possible to effectively suppress an oscillation of the sheet that has been subjected to the lateral deviation correction.

It is to be noted that in the embodiment described above, the configuration in which the sheet correction mechanism 60 includes the rotation unit 65 and the slide unit 66 has been exemplified. However, the present disclosure is not limited to such a configuration. For example, a configuration in which the sheet correction mechanism 60 includes either one of the rotation unit 65 and the slide unit 66 to carry out only the tilt correction or only the lateral deviation correction may be adopted instead.

In addition, although the image forming apparatus 10 has been exemplified as an example of the image forming apparatus according to the present disclosure in the embodiment described above, the present disclosure is also applicable as a sheet conveying device provided in the image forming apparatus.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. A sheet conveying device, comprising:
a conveying portion that conveys a sheet in a conveying direction directed toward an image transfer position at which an image is transferred onto the sheet;
a detection portion that detects a conveyance deviation of the sheet conveyed in the conveying direction;
a sheet correction portion that is provided on a downstream side of the conveying portion in the conveying direction and is, when the conveyance deviation is detected by the detection portion, displaced from a predetermined sheet acceptance position to a correction completion position, to correct the conveyance deviation; and
a speed control portion that controls a displacement speed of the sheet correction portion during a displacement process of the sheet correction portion from the sheet acceptance position to the correction completion position,
wherein the speed control portion
causes the sheet correction portion to be displaced to a setting position set between the sheet acceptance position and the correction completion position at a predetermined first speed, and
causes the sheet correction portion to be displaced from the setting position to the correction completion position at a second speed lower than the first speed.

2. The sheet conveying device according to claim 1, wherein
the setting position is a position set apart on a side of the correction completion position from a center position between the sheet acceptance position and the correction completion position.

3. The sheet conveying device according to claim 2, wherein
the setting position is a position set apart from the sheet acceptance position toward the side of the correction completion position by a distance obtained by multiplying a distance between the sheet acceptance position and the correction completion position by a setting ratio exceeding 50%.

4. The sheet conveying device according to claim 1, wherein
the sheet correction portion includes a correction roller that conveys the sheet conveyed in the conveying direction, in the conveying direction,
the sheet correction portion causes, when the conveyance deviation of the sheet is detected by the detection portion, the correction roller to be displaced from the sheet acceptance position to the correction completion position only by a displacement amount corresponding to the conveyance deviation after the sheet enters the correction roller, to correct the conveyance deviation, and
the speed control portion controls, as the displacement speed, a roller displacement speed when the correction roller is displaced from the sheet acceptance position to the correction completion position.

5. A sheet conveying device, comprising:
a conveying portion that conveys a sheet in a conveying direction directed toward an image transfer position at which an image is transferred onto the sheet;
a detection portion that detects a conveyance deviation of the sheet conveyed in the conveying direction;
a sheet correction portion that is provided on a downstream side of the conveying portion in the conveying direction, includes a correction roller that conveys the sheet conveyed in the conveying direction, in the conveying direction, and causes, when the conveyance deviation of the sheet is detected by the detection portion, the correction roller to be displaced from a predetermined sheet acceptance position to a correction completion position only by a displacement amount corresponding to the conveyance deviation after the sheet enters the correction roller, to correct the conveyance deviation; and
a speed control portion that controls a displacement speed of the correction roller when the correction roller is displaced from the sheet acceptance position to the correction completion position by the sheet correction portion,
wherein the speed control portion
causes the correction roller to be displaced to a setting position set between the sheet acceptance position and the correction completion position at a predetermined first speed, and
causes the correction roller to be displaced from the setting position to the correction completion position at a second speed lower than the first speed.

6. The sheet conveying device according to claim 4, wherein
the sheet correction portion includes
a rotation unit that is capable of causing the correction roller to rotate about a predetermined rotation fulcrum, causes the correction roller to rotate from a predetermined initial position to the sheet acceptance position only by a rotation distance corresponding to the conveyance deviation of the sheet before the sheet enters the correction roller, and causes the correction roller to return from the sheet acceptance position to the initial position as the correction completion position after the sheet enters the correction roller.

7. The sheet conveying device according to claim 4, wherein
the sheet correction portion includes
a slide unit that is capable of causing the correction roller to slide in an axial direction from a predetermined reference position, and causes the correction roller to slide in the axial direction from the reference position only by a movement distance corresponding to the conveyance deviation of the sheet after the sheet enters the correction roller.

8. An image forming apparatus, comprising:
the sheet conveying device according to claim 1,
wherein the image forming apparatus transfers an image onto a sheet conveyed to an image transfer position by the sheet conveying device.
